(19) United States
(12) Patent Application Publication
(10) Pub. No.: US 2025/0238010 A1
(43) Pub. Date: Jul. 24, 2025

(54) Method And System for Identifying Home Hazards and Unsafe Conditions Using Artificial Intelligence

(71) Applicant: STATE FARM MUTUAL AUTOMOBILE INSURANCE COMPANY, Bloomington, IL (US)

(72) Inventors: Catherine Espel-Logan, Plano, TX (US); Heather Reginelli, Bloomington, IL (US)

(21) Appl. No.: 18/590,390

(22) Filed: Feb. 28, 2024

Related U.S. Application Data
(60) Provisional application No. 63/624,522, filed on Jan. 24, 2024.

(51) Int. Cl. G05B 19/042

(52) U.S. Cl. CPC G05B 19/0428; G05B 2219/2642

(57) ABSTRACT

Methods and/or systems are described for identifying hazards. The method may include (1) receiving user visual data and hazard data, the hazard data including a hazardous condition associated with one or more of: (i) a hazard or (ii) an environmental condition associated with the hazard; (2) training a machine learning algorithm to classify at least part of the user visual data; (3) classifying at least part of the user visual data to generate a classification of a detected hazardous condition in the at least part of the user visual data; (4) generating a hazard notification corresponding to the classification of the detected hazardous condition in the at least part of the user visual data; and/or (5) causing a user device to provide the hazard notification based upon the classification of the detected hazardous condition in the at least part of the user visual data.

### CROSS-REFERENCE TO RELATED APPLICATIONS

This application claims priority to and the benefit of the filing date of provisional U.S. Patent Application No. 63/624,522 entitled “METHOD AND SYSTEM FOR IDENTIFYING HOME HAZARDS AND UNSAFE CONDITIONS USING ARTIFICIAL INTELLIGENCE,” filed on Jan. 24, 2024. The entire contents of the provisional application are hereby expressly incorporated herein by reference.

### TECHNICAL FIELD

The present disclosure generally relates to smart home technology. More specifically, the present disclosure relates to identifying home hazards and/or unsafe conditions using artificial intelligence (AI) or machine learning techniques.

### BACKGROUND

When individuals evaluate an environment, it may be difficult to recognize potential hazards. For example, poor vision or visibility, deteriorated hearing, impaired cognitive ability, and/or other such factor may impair the ability of an individual to identify potential hazards accurately and/or successfully in an environment. Moreover, any potential hazards that are recognized may not be fully appreciated for the potential risk they pose to life, property, long-term health, and/or other similarly valuable considerations.

Further, conventional methods of hazard detection may require relying upon the learned behaviors and/or experiences of a particular individual. As such, conventional methods may be constrained and/or biased by an individual's limited set of learned behaviors and/or experiences.

Additionally, conventional techniques may be reactive in nature such that they may not alert a user until a hazardous event has occurred. For example, a smoke alarm may alert a user after enough smoke has been detected due to an already existing fire. As such, conventional techniques may be inadequate at preventing hazardous conditions from existing in the first place. Reactive hazard detection techniques may be insufficient for mitigating and/or preventing potential risk to life, property, and/or long-term health.

Even further, elderly individuals may suffer from a variety of medical ailments, such as Alzheimer's, which reduce their cognitive ability causing difficulty remembering recent events. This memory problem may pose an extreme risk to elderly individuals that are independent and/or may still cook for themselves. For example, an elderly person may turn on a stove to begin cooking and then leave forgetting that the stove is on. This unattended heating element may pose a hazard not only to the elderly individual and/or their home, but also to anyone else present, such as a child or pet.

Conventional techniques may have other ineffectiveness, insecurities, difficulties, inefficiencies, encumbrances, and/or other drawbacks as well.

### SUMMARY

The present embodiments may relate to, inter alia, a computer-implemented method for detecting hazardous conditions using a Machine Learning (ML) and/or Artificial Intelligence (AI) model.

In one aspect, a computer-implemented method for detecting hazardous conditions may be provided. The method may be implemented via one or more local or remote processors, servers, sensors, transceivers, memory units, mobile devices, wearables, smart glasses, Augmented Reality (AR) glasses, Virtual Reality (VR) glasses, smart contacts, mixed or extended reality glasses or headsets, voice bots, chatbots, ChatGPT bots, ChatGPT-based bots, language models (e.g., large language models (LLMs), small language models (SLMs), etc.), and/or other electronic or electrical components, which may be in wired or wireless communication with one another. For example, in one instance, the method may include: (1) receiving, by one or more processors and/or at least one database, user visual data and/or hazard data, the hazard data including a hazardous condition associated with one or more of: (i) a hazard or (ii) an environmental condition associated with the hazard; (2) training, by the one or more processors and/or using the hazard data, a machine learning algorithm to classify at least part of the user visual data; (3) classifying, by the one or more processors and/or using the machine learning algorithm, at least part of the user visual data to generate a classification of a detected hazardous condition in the at least part of the user visual data; (4) generating, by the one or more processors, a hazard notification corresponding to the classification of the detected hazardous condition in the at least part of the user visual data; and/or (5) causing, by the one or more processors, a user device to provide the hazard notification based upon the classification of the detected hazardous condition in the at least part of the user visual data. The method may include additional, less, or alternate actions and/or functionality, including that discussed elsewhere herein.

For example, the computer-implemented method may further include a hazard level of a plurality of hazard levels associated with the classification of the detected hazardous condition in the at least part of the user visual data. For instance, a hazardous condition that does not pose a significant risk to life or health may be a Level I hazard whereas a hazardous condition that poses a significant risk to health may be a Level II hazard, and/or a hazardous condition that poses a significant risk to life may be a Level III hazard, etc. Similarly, a hazardous condition that only poses a risk to property may be a lower hazard level than a hazardous condition that poses a risk to life and/or health.

The hazard notification may include a recommended action based upon the detected hazardous condition in at least part of the user visual data. For example, a hazardous condition such as a leaking toilet, may be detected. The recommended action may be step-by-step instructions on how to fix the leaking toilet; a recommended list of certified local plumbers; a recommended list of stores that sell toilet parts; etc.

Additionally or alternatively, the hazard data may further include a known hazardous condition associated with a hazard mitigating object. For instance, a hazardous condition, such as a fire risk, may be associated with a hazard mitigating object like a fire extinguisher. Similarly, a hazardous condition, such as injury from riding a bike, may be associated with a hazard mitigating object like a bike helmet. Again, a hazardous condition, such as a drowning risk (such as to a toddler), may be associated with a hazard mitigating object like the presence of a fence or barrier around a pool.

Additionally or alternatively, the hazardous conditions associated with the hazard mitigating object may be a defect with the hazard mitigating object. For example, a hazardous condition, such as a fire risk, may be associated with a defective hazard mitigating object like a non-code compliant fire extinguisher. Moreover, a hazardous condition, such as injury from riding a bike, may be associated with a defective hazard mitigating object like a bike helmet that does not fit correctly, a user wearing clothes that are not reflective enough, a bike missing safety features such as lights, etc. Further still, a hazardous condition, such as a drowning risk, may be associated with a defective hazard mitigating object like a fence or barrier around a pool that is easily climbable by a child or with a lock/latch that is not child-proof.

Additionally or alternatively, the hazardous condition may be representative of the presence of an unauthorized entity. For example, a hazardous condition, such as a fire risk, may be representative of the presence of a child near an unattended stove. Similarly, a hazardous condition, such as a bike fall risk, may be representative of the presence of a child on an adult sized bike. Yet again, a hazardous condition like a drowning risk may be representative of the presence of a child near a pool.

In another aspect, a computing system for hazard detection may be provided. The computing system may include one or more local or remote processors, servers, sensors, transceivers, memory units, mobile devices, wearables, smart glasses, augmented reality glasses, virtual reality glasses, smart contacts, mixed or extended reality glasses or headsets, voice bots, chatbots, ChatGPT bots, ChatGPT-based bots, and/or other electronic or electrical components, which may be in wired or wireless communication with one another. For example, the system may include one or more processors; a communication unit; and/or a non-transitory computer-readable medium coupled to the one or more processors and/or the communication unit and/or storing instructions thereon that, when executed by the one or more processors, cause the computing device to: (1) receive, from at least one database, user visual data and/or hazard data, the hazard data including a hazardous condition associated with one or more of: (i) a hazard or (ii) an environmental condition associated with the hazard; (2) train, using the hazard data, a machine learning algorithm to classify at least part of the user visual data; (3) classify, using the machine learning algorithm, at least part of the user visual data to generate a classification of a detected hazardous condition in the at least part of the user visual data; (4) generate, a hazard notification corresponding to the classification of the detected hazardous condition in the at least part of the user visual data; and/or (5) cause a user device to provide the hazard notification based upon the classification of the detected hazardous condition in the at least part of the user visual data. The computing system may include additional, less, or alternate functionality, including that discussed elsewhere herein.

In another aspect, a tangible, non-transitory computer-readable medium storing instructions for detecting hazards may be provided. The non-transitory computer-readable medium stores instructions that, when executed by one or more processors of a computing device, cause the computing device to: (1) receive, from at least one database, user visual data and/or hazard data, the hazard data including a hazardous condition associated with one or more of: (i) a hazard or (ii) an environmental condition associated with the hazard; (2) train, using the hazard data, a machine learning algorithm to classify at least part of the user visual data; (3) classify, using the machine learning algorithm, at least part of the user visual data to generate a classification of a detected hazardous condition in the at least part of the user visual data; (4) generate, a hazard notification corresponding to the classification of the detected hazardous condition in the at least part of the user visual data; and/or (5) cause a user device to provide the hazard notification based upon the classification of the detected hazardous condition in the at least part of the user visual data. The computer-readable medium may include instructions that provide additional, less, or alternate functionality, including that discussed elsewhere herein.

This summary is provided to introduce a selection of concepts in a simplified form that are further described in the Detailed Descriptions. This summary is not intended to identify key features or essential features of the claimed subject matter, nor is it intended to be used to limit the scope of the claimed subject matter.

Advantages will become more apparent to those of ordinary skill in the art from the following description of the preferred aspects, which have been shown and/or described by way of illustration. As will be realized, the present aspects may be capable of other and/or different aspects, and their details are capable of modification in various respects. Accordingly, the drawings and/or description are to be regarded as illustrative in nature and not as restrictive.

### BRIEF DESCRIPTION OF THE DRAWINGS

The figures described below depict various aspects of the system and/or methods disclosed therein. It should be understood that each figure depicts at least one embodiment of a particular aspect of the disclosed system and/or methods, and that each of the figures is intended to accord with possible embodiments thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and/or instrumentalities shown, wherein:

FIG. 1 depicts an exemplary computing environment for facilitating hazard detection, implemented according to certain embodiments.

FIG. 2 depicts a combined block and logic diagram in which exemplary computer-implemented methods and/or systems for training a machine learning (ML) and/or an artificial intelligence (AI) model are implemented according to certain embodiments.

FIG. 3A depicts an exemplary interface through which a user may interact with a machine learning (ML) and/or an artificial intelligence (AI) model as described with regard to FIG. 2.

FIG. 3B depicts another exemplary interface through which a user may interact with a machine learning (ML) and/or an artificial intelligence (AI) model as described with regard to FIG. 2.

FIG. 4 depicts a flow diagram representing an exemplary computer-implemented method for using a machine learning (ML) and/or artificial intelligence (AI) model to detect hazards.

The Figures depict preferred embodiments for purposes of illustration only. One skilled in the art will readily recognize from the following discussion that alternative embodiments of the systems and/or methods illustrated herein may be employed without departing from the principles of the invention described herein.

### DETAILED DESCRIPTION

Techniques, systems, apparatuses, components, devices, and/or methods are disclosed for, inter alia, detecting hazards using a machine learning (ML) and/or artificial intelligence (AI) model. For example, a system may receive user visual data and/or hazard data and/or train a machine learning model to detect hazardous conditions. The machine learning model may then detect hazardous conditions in at least part of the user visual data. In some scenarios, the system may generate a hazard notification regarding a detected hazard. In further scenarios, a computing device may provide a user with a hazard notification corresponding to the classified detected hazardous condition. In some such embodiments, the computing device may further provide a user with recommended actions to mitigate or eliminate the hazardous condition.

Some classes of individuals, such as elderly individuals and/or those suffering from memory problems, may benefit from a safety net ensuring that unrecognized or underappreciated hazardous conditions are mitigated or eliminated. However, such individuals and/or their families may not have the means to have a full-time caretaker to ensure there are no risks present in an environment. By training and/or using a machine learning model trained on user visual data and/or hazard data, a system can collect and/or analyze large quantities of data to determine what hazardous conditions are present in an environment. Moreover, by training and/or using a machine learning data evaluation model, the system can identify otherwise invisible trends and/or relations between hazardous conditions, environments, and/or other potentially impactful characteristics. As such, the system may generate a hazard notification, a plurality of hazard levels, and/or a recommended action based upon the detected hazardous condition in an environment.

More specifically, the computer system may detect a hazardous condition and/or generate a hazard notification based upon factors, such as the user visual data and/or hazard data. In some embodiments, the system retrieves and/or analyzes hazard data and/or user visual data using a machine learning model to determine and/or weight the relevant factors. The present invention improves upon conventional techniques by being proactive in determining the presence of a hazardous condition. Conventional techniques that are reactive in nature (e.g., a smoke alarm that alerts a user due to an already existing fire) are ineffective at mitigating or eliminating risk. By providing a prospective determination on the likelihood that a hazardous condition exists, the potential risk to life, property, and/or long-term health is greatly reduced.

In some embodiments, the system may cause a user device or smart device to provide a user with a hazard notification. In further embodiments, the system may cause a user device or smart device to provide a user with recommended actions to mitigate or eliminate a hazardous condition. Depending on the embodiment, the system may determine a hazard level based upon different factors. For example, the system may calculate a hazard level for a hazardous condition posing risk to property differently than the system may calculate a hazard level for a hazardous condition posing risk to the life or health of a user. Similarly, the system may cause a user device or smart device to provide a user with the hazard level, recommended actions to mitigate or eliminate the hazardous condition depending on the application. In further embodiments, the system may cause a user device or smart device to provide a user with a hazard notification and/or recommended actions to mitigate or eliminate the hazardous conditions in response to receiving an indication and/or request from the user.

The present embodiments relate to computing systems and/or computer-implemented methods for detecting hazardous conditions in an environment. The environment may be indoors and/or outdoors at a home (e.g., a living room, a kitchen, a bathroom, a bedroom, a nursery, a hallway, a staircase, a home office, a garage, a basement, an attic, a patio, a porch, a window well, etc.), at a place of work (e.g., an office, a cubicle, a conference room, a break room, a lobby, a reception area, a warehouse, a factory, etc.), at a school (e.g., a classroom, a library, a cafeteria, a gymnasium, an auditorium, a hallway, an office, a restroom, etc.), in a public place (e.g., a hospital, a nursing home, a government building, a courthouse, a library, a museum, a theater, a cinema, a mall, a supermarket, a restaurant, a bar, a hotel, an airport, a train station, a bus station, etc.), and/or any other such property. The environment may also be outdoors, such as in a park, a plaza, a market, a parking lot, a construction site, etc. It is to be understood that the list of environments is not an exhaustive list, is provided for illustrative purposes, and may include more, fewer, or different environments.

### Exemplary Computing Environment

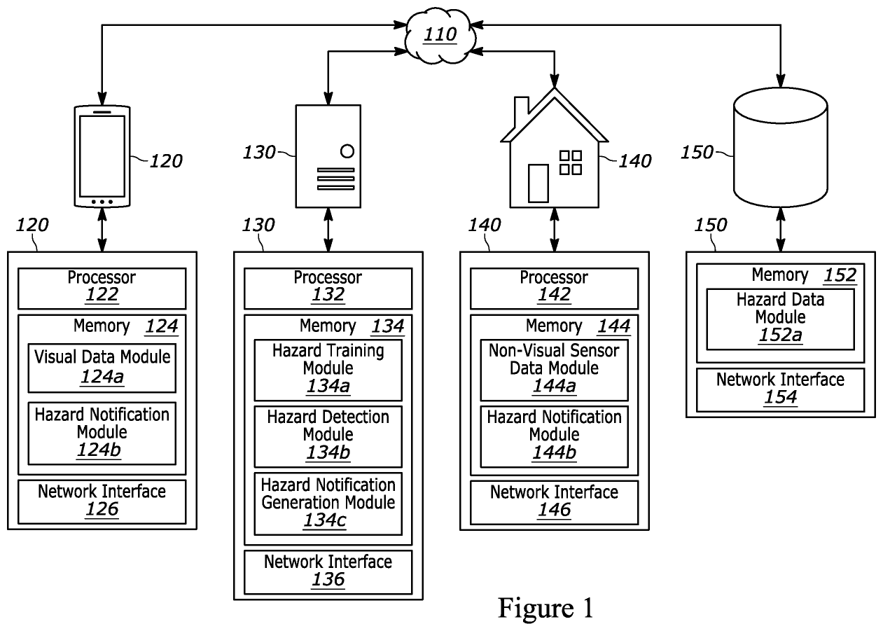

FIG. 1 depicts an exemplary computing environment 100 in which various embodiments of the present disclosure may be implemented, in some aspects. Generally, the exemplary computing environment 100 may be or include the various computing devices and/or components that execute some/all of the functions described herein. The exemplary computing environment 100 may include and/or otherwise utilize one or more computing devices (e.g., on-premises server(s), cloud-based server(s), desktop/laptop computers, smartphones and/or other smart devices, or the like) that are communicatively connected (e.g., via a network connection) to one another and/or are configured to transmit, receive, and/or process data related to hazard detection. The exemplary computing environment 100 may include a user device 120, a server 130, a smart device 140, and/or a hazard database 150. Such computing devices may be communicatively coupled to an electronic network 110. It will be understood that, depending on the embodiment, the computing environment 100 may include more, fewer, and/or alternate components to the user device 120, server 130, smart device 140, and/or hazard database 150.

The user device 120 may be embodied by various computing devices, such as a smartphone, a tablet, a laptop, a desktop computer, etc. In some embodiments, the user device 120 may include aspects of one or more of the foregoing in combination, such as smartphone tablet combination (e.g., a phablet) or a tablet laptop combination (e.g., a 2-in-1 tablet laptop), etc. The user device 120 may include one or more processors 122, the memory 124, and/or a network interface 126.

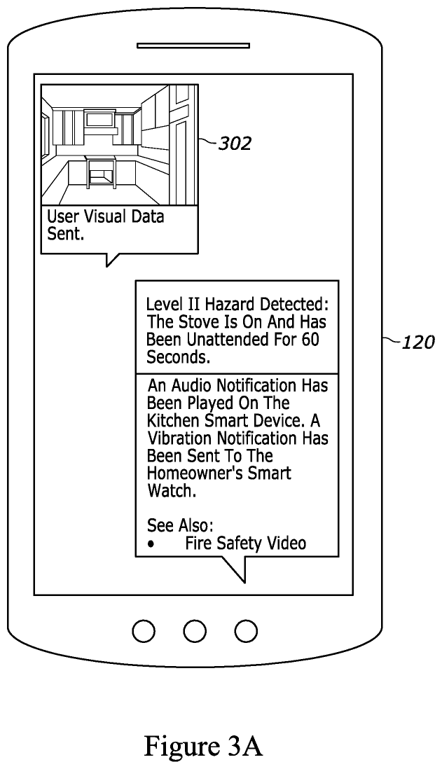

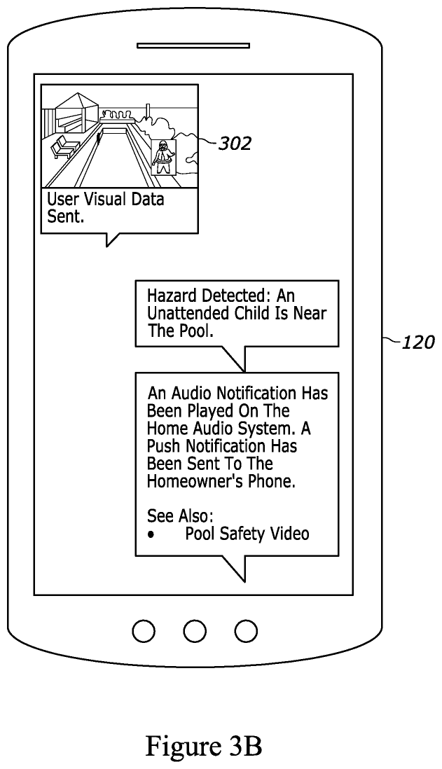

The one or more processors 122 may include any suitable number of processors and/or processor types. The one or more processors 122 may include one or more CPUs and/or one or more graphics processing units (GPUS), for example. Generally, the one or more processors 122 may be configured to execute software instructions stored in memory 124. The memory 124 may include one or more persistent memories (e.g., a hard drive and/or solid-state memory) and/or may store one or more modules, including a visual data module 124a and/or a hazard notification module 124b. The visual data module 124a may be responsible for capturing (e.g., through a pre-installed camera and/or video capture application) and/or sending user visual data (e.g., image data and/or video data) to the server 130 for hazard detection. User visual data may generally represent a particular environment and is further described below in reference to FIGS. 3A and 3B.

The hazard notification module 124b may generally generate and/or provide a user with a hazard notification corresponding to the classified detected hazardous condition in at least part of the user visual data (e.g., a bike is not locked and at risk of theft, an oven is left unattended for more than a predetermined period of time, a small child is wandering around a pool, etc.). Detected hazardous conditions may generally represent a particular environmental condition that the machine learning (ML) model and/or artificial intelligence (AI) model classifies according to the user visual data and/or hazard data that the machine learning (ML) model and/or artificial intelligence (AI) model is trained on. In some embodiments, the hazard notification module 124b may be responsible for providing the user with a hazard notification corresponding to the classified detected hazardous condition in at least part of non-visual sensor data sent by another device (e.g., a smart device 140). In further embodiments, the hazard notification module 124b may be or include an application on a user device 120, configured to trigger and/or push a notification after determining that a hazard has been detected, or in response to another trigger as discussed herein.

Non-visual sensor data may generally include a variety of environmental parameters, such as ambient temperature, relative humidity, wind speed and/or direction, ultraviolet (UV) radiation, pH level, sound pressure, radon concentration, pollen count, volatile organic compound (VOC) concentration, smoke levels, carbon monoxide concentration, water presence, water pressure, water levels, vibration amplitude or frequency, power usage, seismic activity, G-force, etc. It is to be understood that the list of environmental parameters that may be generally included as non-visual sensor data is not an exhaustive list and is provided for illustrative purposes and may include more, less, or different environmental parameters.

The network interface 126 may support wired or wireless communications, such as universal serial bus (USB), Bluetooth, Wi-Fi Direct, Near Field Communication (NFC), etc. The networking interface 126 may enable the user device 120 to communicate with the other various components of the exemplary computing environment 100 via a wireless communication network, such as a fifth-, fourth-, or third-generation cellular network (5G, 4G, or 3G, respectively), a Wi-Fi network (802.11 standards), a WiMAX network, a wide area network (WAN), a local area network (LAN), the Internet, etc. It should be understood that the networking interface 126 may also enable the user device 120 to communicate with other various computing devices not depicted as components of the exemplary computing environment 100.

The server 130 may include the use of various types or kinds of servers (e.g., physical servers, virtual servers, database servers, DNS servers, email servers, etc.). The server 130 may include one or more processors 132, a memory 134, and/or a network interface 136. The one or more processors 132 may include any suitable number of processors and/or processor types. The one or more processors 132 may include one or more CPUs and/or one or more graphics processing units (GPUs), for example. Generally, the one or more processors 132 may be configured to execute software instructions stored in memory 134. The memory 134 may include one or more persistent memories (e.g., a hard drive and/or solid state memory) and/or may store one or more modules, including a hazard training module 134a, a hazard detection module 134b, and/or a hazard notification generation module 134c.

The hazard training module 134a is generally responsible for receiving hazard data and/or training a machine learning (ML) and/or artificial intelligence (AI) model to detect hazardous conditions. Detected hazardous conditions may generally include anything that the trained machine learning (ML) and/or artificial intelligence (AI) model classifies as a hazardous condition according to the hazard data. The hazard data may generally include a hazardous condition associated with one or more of: (i) a hazard or (ii) an environmental condition associated with the hazard.

For example, hazard data may include a hazardous condition associated with a hazard and/or a photo or video depicting the hazard. Some such examples may include a fire risk and/or a picture or video of an unattended stove, a water damage risk and/or a picture or video of a loose gasket on a toilet, an injury risk and/or a picture or video of an improperly fitting bicycle helmet on a person, a drowning risk and/or a picture or video of a small child near a pool, a theft risk and/or a picture or video of an unlocked bike in a garage, a fall risk and/or a picture or video of a poorly lit stairway, an electrocution risk and/or a picture or video of overloaded outlets, a foodborne illness risk and/or a picture or video of improper food storage, a choking risk and/or a picture or video of a child in proximity to small food items, a slip risk and/or a picture or video of a wet hallway, a suffocation risk and/or a picture or video of loose bedding in a crib, etc.

In some embodiments, the hazard data may include a hazardous condition associated with a hazard and/or a photo or video depicting the absence of a hazard mitigation object. Some such examples may include a fire risk and/or a photo or video of a kitchen without a fire extinguisher in proximity to a stove, a slip and/or fall risk and/or a photo or video of a water spill without a wet floor sign, a visibility risk and/or a photo or video of a bike without reflectors, etc.

In other embodiments, the hazard data may include a hazardous condition associated with a hazard and/or non-visual data. Some such examples may include a carbon monoxide poisoning risk and/or non-visual sensor data of carbon monoxide levels, a heat stroke risk and/or non-visual sensor data of ambient temperature, a sunburn risk and/or non-visual sensor data of ultraviolet (UV) radiation, an allergy risk and/or non-visual sensor data of pollen count, a flooding risk and/or non-visual sensor data of water levels, a building collapse risk and/or non-visual sensor data of seismic activity, etc.

Further still, in some embodiments, the hazard data may include a hazardous condition associated with a hazard and/or any combinations of the aforementioned (e.g., a picture or video and/or non-visual sensor data, non-visual sensor data and/or the absence of a hazard mitigation object, a picture or video and/or a picture or video depicting the absence of a hazard mitigating object). Some such examples may include a fire risk and/or a photo or video of smoke and/or non-visual sensor data of smoke levels, a fall risk and/or a photo or video of a person on the ground and/or non-visual sensor data of G-force, an electrocution risk and/or a photo or video of overloaded outlets and/or non-visual sensor data of power consumption, etc.

In some embodiments, hazard data may include a hazardous condition associated with just a hazard, such as a textual list of common hazards for households, offices, schools, etc. The trained machine learning (ML) and/or artificial intelligence (AI) model may include and/or derive functionality from a language model such as a large language model (LLM) or a small language model (SLM) to process the textual list included in the hazard data. The trained machine learning (ML) and/or artificial intelligence (AI) model may use large training datasets of text included in the hazard data which may provide sophisticated capability for natural-language tasks, such as answering questions and/or holding conversations. The trained machine learning (ML) and/or artificial intelligence (AI) model may include a general-purpose pretrained LLM or a pretrained SLM which, when provided with a starting set of words (e.g., a prompt) as an input, may attempt to provide an output (e.g., a response) of the most likely set of words that follow from the input. The trained machine learning (ML) and/or artificial intelligence (AI) model may include Bayesian program learning (BPL), optical character recognition (OCR), and/or natural language processing, either individually or in combination. The machine learning programs may also include natural language processing, semantic analysis, automatic reasoning, and/or machine learning.

In other embodiments, hazard data may include a hazardous condition associated with just an environmental condition associated with the hazard, such as photos or images of common hazards, photos or images of common hazard mitigating objects, non-visual sensor data of hazardous levels of a variety of environmental parameters, and/or any combinations thereof.

It is to be understood that the lists of hazard data and/or resultingly detected hazardous conditions is not an exhaustive list and is provided for illustrative purposes and may include more, fewer, or different hazardous conditions associated with one or more of: (i) a hazard or (ii) an environmental condition associated with the hazard. Hazard data may be obtained from a variety of sources, such as proprietary training databases and/or from a user in the form of user visual data or non-visual sensor data among other sources.

The hazard detection module 134b may utilize the trained machine learning (ML) and/or artificial intelligence (AI) model to detect hazardous conditions in at least part of the user visual data or non-visual sensor data received. In certain embodiments, the hazard detection module 134b may detect multiple hazardous conditions in at least part of the user visual data or non-visual sensor data received. The hazard notification generation module 134c may generate hazard notifications corresponding to the detected hazardous condition in at least part of the user visual data or non-visual sensor data. In some embodiments, the hazard notification generation module 134c may generate multiple hazard notifications.

In some embodiments, the server 130 may include the use of various servers for hosting the hazard training module 134a, the hazard detection module 134b, and/or the hazard notification generation module 134c (e.g., on-premises hosting, colocation hosting, managed hosting, hybrid-cloud hosting, etc.).

The network interface 136 may support wired or wireless communications, such as universal serial bus (USB), Bluetooth, Wi-Fi Direct, Near Field Communication (NFC), etc. The networking interface 136 may enable the server 130 to communicate with the other various components of the exemplary computing environment 100 via a wireless communication network, such as a fifth-, fourth-, or third-generation cellular network (5G, 4G, or 3G, respectively), a Wi-Fi network (802.11 standards), a WiMAX network, a wide area network (WAN), a local area network (LAN), the Internet, etc. It will be understood that the networking interface 136 may also enable the server 130 to communicate with other various computing devices not depicted as components of the exemplary computing environment 100.

The smart device 140 may include one or more processors 142, a memory 144, and/or a network interface 146. The one or more processors 142 may include any suitable number of processors and/or processor types. The one or more processors 142 may include one or more CPUs and/or one or more graphics processing units (GPUs), for example. Generally, the one or more processors 142 may be configured to execute software instructions stored in memory 144. The memory 144 may include one or more persistent memories (e.g., a hard drive and/or solid state memory) and/or may store one or more modules, including a non-visual sensor data module 144a and/or a hazard notification module 144b. In general, the non-visual sensor data module 144a may collect non-visual sensor data and/or transmit the non-visual sensor data via the network 110 to the server 130 for use by the hazard detection module 134b.

Non-visual sensor data may generally include a variety of environmental parameters, such as ambient temperature, relative humidity, wind speed and/or direction, sunlight and/or ultraviolet (UV) radiation, pH level, sound pressure, radon concentration, pollen count, volatile organic compound (VOC) concentration, dangerous organic materials (e.g., mold spores, asbestos, chemicals, etc.), smoke levels, carbon monoxide concentration, water presence, water pressure, water levels, vibration amplitude or frequency, power usage, seismic activity, G-force, etc. It is to be understood that the list of environmental parameters that may be generally included as non-visual sensor data is not an exhaustive list and is provided for illustrative purposes and may include more, less, or different environmental parameters.

The hazard notification module 144b is generally responsible for providing a user with a hazard notification corresponding to the classified detected hazard. In some embodiments, the smart device 140 may provide hazard notifications corresponding to a hazard detected in at least part of the user visual data obtained by the user device 120.

The network interface 146 may support wired or wireless communications, such as universal serial bus (USB), Bluetooth, Wi-Fi Direct, Near Field Communication (NFC), etc. The networking interface 146 may enable the smart device 140 to communicate with the other various components of the exemplary computing environment 100 via a wireless communication network, such as a fifth-, fourth-, or third-generation cellular network (5G, 4G, or 3G, respectively), a Wi-Fi network (802.11 standards), a WiMAX network, a wide area network (WAN), a local area network (LAN), the Internet, etc. It will be understood that the networking interface 146 may also enable the smart device 140 to communicate with other various computing devices not depicted as components of the exemplary computing environment 100.

The hazard database 150 may include a memory 152. The memory 152 may include one or more persistent memories (e.g., a hard drive and/or solid state memory) and/or may store one or more modules, including a hazard data module 152a for storing a plurality of hazard data. The hazard data may generally include a hazardous condition associated with one or more of: (i) a hazard or (ii) an environmental condition associated with the hazard.

For example, hazard data may include a hazardous condition associated with a hazard and/or a photo or video depicting the hazard. Some such examples may include a fire risk and/or a picture or video of (i) an unattended stove; (ii) a water damage risk and/or a picture or video of a loose gasket on a toilet; (iii) an injury risk and/or a picture or video of an improperly fitting bicycle helmet on a person; (iv) a drowning risk and/or a picture or video of a small child near a pool; (v) a theft risk and/or a picture or video of an unlocked bike in a garage; (vi) a fall risk and/or a picture or video of a poorly lit stairway; (vii) an electrocution risk and/or a picture or video of overloaded outlets, a foodborne illness risk and/or a picture or video of improper food storage; (viii) a choking risk and/or a picture or video of a child in proximity to small food items;

(ix) a slip risk and/or a picture or video of a wet hallway; (x) a suffocation risk and/or a picture or video of loose bedding in a crib; etc.

In some embodiments, the hazard data may include a hazardous condition associated with a hazard and/or a photo or video depicting the absence of a hazard mitigation object. Some such examples may include (a) a fire risk and/or a photo or video of a kitchen without a fire extinguisher in proximity to a stove; (b) a slip and/or fall risk and/or a photo or video of a water spill without a wet floor sign; (c) a visibility risk and/or a photo or video of a bike without reflectors; etc.

In other embodiments, the hazard data may include a hazardous condition associated with a hazard and/or non-visual data. Some such examples may include (i) a carbon monoxide poisoning risk and/or non-visual sensor data of carbon monoxide levels; (ii) a heat stroke risk and/or non-visual sensor data of ambient temperature; (iii) a sunburn risk and/or non-visual sensor data of ultraviolet (UV) radiation; (iv) an allergy risk and/or non-visual sensor data of pollen count; (v) a flooding risk and/or non-visual sensor data of water levels; (vi) a building collapse risk and/or non-visual sensor data of seismic activity; etc.

Further still, in some embodiments, the hazard data may include a hazardous condition associated with a hazard and/or any combinations of the aforementioned (e.g., a picture or video and non-visual sensor data, non-visual sensor data and the absence of a hazard mitigation object, a picture or video and a picture or video depicting the absence of a hazard mitigating object, etc.). Some such examples may include (i) a fire risk and/or a photo or video of smoke and/or non-visual sensor data of smoke levels; (ii) a fall risk and/or a photo or video of a person on the ground and/or non-visual sensor data of G-force; (iii) an electrocution risk and/or a photo or video of overloaded outlets and/or non-visual sensor data of power consumption; etc.

In some embodiments, hazard data may include a hazardous condition associated with just a hazard, such as a textual list of common hazards in households, offices, schools, etc. The trained machine learning (ML) and/or artificial intelligence (AI) model may include and/or derive functionality from a language model such as a large language model (LLM) or a small language model (SLM) to process the textual list included in the hazard data. The trained machine learning (ML) and/or artificial intelligence (AI) model may use large training datasets of text included in the hazard data which may provide sophisticated capability for natural-language tasks, such as answering questions and/or holding conversations. The trained machine learning (ML) and/or artificial intelligence (AI) model may include a general-purpose pretrained LLM or a pretrained SLM which, when provided with a starting set of words (e.g., a prompt) as an input, may attempt to provide an output (e.g., a response) of the most likely set of words that follow from the input. The trained machine learning (ML) and/or artificial intelligence (AI) model may include Bayesian program learning (BPL), optical character recognition, and/or natural language processing, either individually or in combination. The machine learning programs may also include natural language processing, semantic analysis, automatic reasoning, and/or machine learning.

In other embodiments, hazard data may include a hazardous condition associated with just an environmental condition associated with the hazard, such as photos or images of common hazards, photos or images of common hazard mitigating objects, non-visual sensor data of hazardous levels of a variety of environmental parameters, and/or any combinations thereof.

Again, it is to be understood that the list of hazard data is not an exhaustive list and is provided for illustrative purposes and may include more, less, or different hazardous conditions associated with one or more of: (i) a hazard or (ii) an environmental condition associated with the hazard. Hazard data may be obtained from a variety of sources, such as proprietary training databases and/or from a user in the form of user visual data or non-visual sensor data among other sources.

The user device 120, the server 130, the smart device 140, and/or the hazard database 150 may be communicatively coupled by the network 110. For example, the user device 120 and/or the smart device 140 may communicate via universal serial bus (USB), Bluetooth, Wi-Fi Direct, Near Field Communication (NFC), etc. The smart device 140 may transmit files, documents, text, information, values, responses, and/or other such data, or combinations thereof via the network interface 146 and/or the network 110 to the user devices 120 via the network interface 126. Each of the user device 120, server 130, smart device 140, and/or hazard database 150 may communicate with each component of the exemplary computing environment 100 via their respective network interface 126, 136, 146, 154 or otherwise.

The network 110 may be a single communication network or a multiple communication network including one or more types (e.g., one or more wired and/or wireless personal or local area networks (PANs or LANs), and/or one or more wide area networks (WANs), such as the Internet). In some embodiments, the network 110 may include multiple, entirely distinct networks (e.g., one or more networks for communications between the user device 120 and/or the smart device 140 and/or a separate, Bluetooth or wireless LAN (WLAN) network for communications between the server 130 and/or hazard database 150, and so on).

In operation the server 130 receives hazard data for training a machine learning (ML) and/or artificial intelligence (AI) model using the hazard training module 134a. The hazard data may include text, images, videos, and/or other non-visual sensor data associated with a detected hazardous condition.

In some embodiments, a user (e.g., a caretaker, a teacher, a businessowner, etc.) using the user device 120 (e.g., a camera enabled smartphone, etc.) may obtain user visual data (e.g., a picture, video, etc.) of a particular environment (e.g., a living room, classroom, office, etc.). The user visual data may be sent by the user device 120 to the server 130 via the network 110 using the visual data module 124a. The server 130 using the hazard detection module 134b utilizes the trained machine learning (ML) and/or artificial intelligence (AI) model to detect hazardous conditions (e.g., a flammable material in proximity to and/or stored near a (potential) flame, unattended candles, or other lit objects, etc.). After a hazardous condition is detected, the server 130 using the hazard notification generation module 134c sends a hazard notification to the user device 120 or otherwise. The user device 120 using the hazard notification module 124b receives the hazard notification and/or provides it to the user (e.g., a push notification, etc.).

In other embodiments, a user (e.g., a business owner) may configure the smart device 140 to obtain non-visual sensor data (e.g., a water level) of a particular environment (e.g., an office). The non-visual sensor data may be sent by the smart device 140 to the server 130 via the network 110 using the non-visual sensor data module 144a. The server 130 using the hazard detection module 134b utilizes the trained machine learning (ML) and/or artificial intelligence (AI) model to detect hazardous conditions (e.g., flooding risk). After a hazardous condition (e.g., flooding risk) is detected, the server 130 using the hazard notification generation module 134c may send a hazard notification to one or more user devices 120 (e.g., the businessowner's smartphone, a handyman's smartphone, a predetermined list of workers smartphones, etc.) and/or the smart device 140. The user device 120 using the hazard notification module 124b receives the hazard notification and/or provides it to the user (e.g., a push notification). The smart device 140 using the hazard notification module 144b receives the hazard notification and/or provides it to the user (e.g., playing a warning alarm, etc.).

### Exemplary Machine Learning (ML) Embodiments

The exemplary computing environment 100 or computing system may detect a hazardous condition from the hazard data using a machine learning model. The machine learning model may be trained based upon a plurality of hazard data, including a hazardous condition associated with one or more of: (i) a hazard or (ii) an environmental condition associated with the hazard. The machine learning model may use the hazard data to generate a hazard notification corresponding to the classified detected hazard. In some embodiments, the machine learning model may use the hazard data to generate a hazard notification.

Machine learning techniques have been developed that allow parametric or nonparametric statistical analysis of large quantities of data. Such machine learning techniques may be used to automatically identify relevant variables (i.e., variables having statistical significance or a sufficient degree of explanatory power) from data sets. This may include identifying relevant variables or estimating the effect of such variables that indicate actual observations in the data set. This may also include identifying latent variables not directly observed in the data (e.g., variables inferred from the observed data points).

In some embodiments, the methods and/or systems described herein may use machine learning techniques to detect and/or estimate the hazard level of observed (e.g., visual) or latent (e.g., non-visual) variables, such as fire risk, water damage risk, injury risk, drowning risk, theft risk, falling risk, electrocution risk, foodborne illness risk, choking risk, slipping risk, suffocation risk, visibility risk, carbon monoxide poisoning risk, heat stroke risk, sunburn risk, allergy risk, flooding risk, building collapse risk, ambient temperature, relative humidity, wind speed and/or direction, sunlight and/or ultra violet (UV) radiation, pH level, sound pressure, radon concentration, pollen count, volatile organic compound (VOC) concentration, smoke levels, carbon monoxide concentration, water presence, water pressure, water levels, vibration amplitude or frequency, power usage, seismic activity, G-force, etc.

Some embodiments described herein may include automated machine learning to determine hazard levels, identify relevant hazards, and/or perform other functionality as described elsewhere herein. Although the methods described elsewhere herein may not directly mention machine learning techniques, such methods may be read to include such machine learning for any determination or processing of data that may be accomplished using such techniques. In some embodiments, such machine-learning techniques may be implemented automatically upon occurrence of certain events or upon certain conditions being met. Use of machine learning techniques, as described herein, may begin with training a machine learning program, or such techniques may begin with a previously trained machine learning program.

A processor or a processing element may be trained using supervised or unsupervised machine learning, and/or the machine learning program may employ a neural network, which may be a convolutional neural network, a deep learning neural network, or a combined learning module or program that learns in two or more fields or areas of interest. Machine learning may involve identifying and/or recognizing patterns in existing data (such as events involving fire, water damage, injury, drowning, theft, falling, electrocution, foodborne illness, choking, slipping, suffocation, poor biker visibility, carbon monoxide poisoning, heat stroke, sunburn, allergic reaction, flooding, building collapse, etc.) in order to facilitate making predictions for subsequent user visual data and/or non-visual sensor data. Models may be created based upon example inputs of data in order to make valid and/or reliable predictions for novel inputs.

Additionally or alternatively, the machine learning programs may be trained by inputting sample data sets or certain data into the programs, such as user device, server, smart device, sensor and/or control signal data, and/or other data discussed herein. The machine learning programs may utilize deep learning algorithms that are primarily focused on pattern recognition, and/or may be trained after processing multiple examples. The machine learning programs may include Bayesian program learning (BPL), voice recognition and/or synthesis, image or object recognition, optical character recognition, and/or natural language processing, either individually or in combination. The machine learning programs may also include natural language processing, semantic analysis, automatic reasoning, and/or machine learning.

In supervised machine learning, a processing element may be provided with example inputs and/or their associated outputs, and/or may seek to discover a general rule that maps inputs to outputs, so that when subsequent novel inputs are provided the processing element may, based upon the discovered rule, accurately predict the correct or a preferred output. In unsupervised machine learning, the processing element may be required to find its own structure in unlabeled example inputs. In one embodiment, machine learning techniques may be used to extract the non-visual sensor data collected by smart devices or otherwise, and/or under what conditions the non-visual sensor data was generated.

The machine learning programs may be trained with hazard data, including any combination of non-visual sensor data, user visual data, and/or other such data as described herein, to identify hazardous conditions. The machine learning program may also be trained with hazard data including an associated hazard level corresponding to the relative threat to life, health, property, or other such considerations.

Hazard data may include a hazardous condition associated with a hazard and/or a photo or video depicting the hazard. Some such examples include as a fire risk and/or a picture or video of an unattended stove, a water damage risk and/or a picture or video of a loose gasket on a toilet, an injury risk and/or a picture or video of an improperly fitting bicycle helmet on a person, a drowning risk and/or a picture or video of a small child near a pool, a theft risk and/or a picture or video of an unlocked bike in a garage, a fall risk and/or a picture or video of a poorly lit stairway, an electrocution risk and/or a picture or video of overloaded outlets, a foodborne illness risk and/or a picture or video of improper food storage, a choking risk and/or a picture or video of a child in proximity to small food items, a slip risk and/or a picture or video of a wet hallway, a suffocation risk and/or a picture or video of loose bedding in a crib, a fire risk and/or a photo or video of a kitchen without a fire extinguisher in proximity to a stove, a slip and/or fall risk and/or a photo or video of a water spill without a wet floor sign, a visibility risk and/or a photo or video of a bike without reflectors, a carbon monoxide poisoning risk and/or non-visual sensor data of carbon monoxide levels, a heat stroke risk and/or non-visual sensor data of ambient temperature, a sunburn risk and/or non-visual sensor data of ultra violet (UV) radiation, an allergy risk and/or non-visual sensor data of pollen count, a flooding risk and/or non-visual sensor data of water levels, a building collapse risk and/or non-visual sensor data of seismic activity, a fire risk and/or a photo or video of smoke and/or non-visual sensor data of smoke levels, a fall risk and/or a photo or video of a person on the ground and/or non-visual sensor data of G-force, an electrocution risk and/or a photo or video of overloaded outlets and/or non-visual sensor data of power consumption, a textual list of common hazards, photos or images of common hazards, photos or images of common hazard mitigating objects, non-visual sensor data of hazardous levels of a variety of environmental parameters, etc.

It is to be understood that the machine learning training set described herein is not an exhaustive list and is provided for illustrative purposes and may include more, less, or different hazardous conditions. Hazard data may be obtained from a variety of sources, such as proprietary training databases and/or from a user in the form of user visual data or non-visual sensor data among other sources.

After training, machine learning programs (or information generated by such machine learning programs) may be used to evaluate additional data. Such data may be related to hazardous conditions, hazard mitigating objects, etc. The trained machine learning programs (or programs utilizing models, parameters, or other data produced through the training process) may then be used for determining, assessing, analyzing, predicting, estimating, evaluating, or otherwise processing new data not included in the training data. Such trained machine learning programs may, therefore, be used to perform part or all of the analytical functions of the methods described elsewhere herein.

In some embodiments, in addition to training one or more models to determine hazardous conditions, hazard mitigating objects, and/or other such hazard-related determinations through hazard data, the system may additionally train and/or use models with large language capabilities, such as generative models. For example, a user may be able to use programmable chatbots, such as that trained (e.g., in the hazard training module 134a) and/or used (e.g., in the hazard detection module 134b) with regards to FIG. 1. This may include a chatbot and/or an ML chatbot (e.g., ChatGPT), to provide a tailored and/or conversational interface for a user. The chatbot may be capable of understanding user requests, providing relevant hazard mitigation techniques, escalating levels of hazards, etc., any of which may assist and/or replace the need for conventional hazard mitigating techniques or systems. Additionally, the chatbot may generate data from user interactions which may be used to personalize future support and/or improve the chatbot's functionality, e.g., when retraining and/or fine-tuning the chatbot.

In certain embodiments, the machine learning chatbot may be configured to utilize artificial intelligence and/or machine learning techniques. For instance, the machine learning chatbot or voice bot may be a ChatGPT chatbot. The machine learning chatbot may employ supervised or unsupervised machine learning techniques, which may be followed by, and/or used in conjunction with, reinforced or reinforcement learning techniques. The machine learning chatbot may employ the techniques utilized for ChatGPT, and/or similar techniques. The machine learning chatbot may be configured to generate verbal, audible, visual, graphic, text, or textual output for either human or other bot/machine consumption or dialogue.

The visual and/or graphic output may include prestored (e.g., stored on the hazard database) visual assets and/or elements that can be overlayed and/or interposed on user visual data. For example, the machine learning chatbot may overlay on user visual data arrows and/or an image of a fire extinguisher which directs a user to the location of the nearest fire extinguisher. In other embodiments, the visual and/or graphic output may interpose on user visual data a hazard symbol where a detected hazardous condition exists. The visual and/or graphic output may include a generated video or image generated content from the chatbot or algorithms and/or may include a video or image composed entirely of pre rendered assets or addressing the concern.

ML chatbots may provide advanced features as compared to a non-ML chatbot. For example, the ML chatbot may include and/or derive functionality from a language model such as a large language model (LLM) or a small language model (SLM). The ML chatbot may be trained on a server, such as server 130, using large training datasets of text which may provide sophisticated capability for natural-language tasks, such as answering questions and/or holding conversations. The ML chatbot may include a general-purpose pretrained LLM or a pretrained SLM which, when provided with a starting set of words (e.g., a prompt) as an input, may attempt to provide an output (e.g., a response) of the most likely set of words that follow from the input. In one aspect, the prompt may be provided to, and/or the response received from, the ML chatbot and/or any other ML model, via the user device 120. This may include the user device 120 operably connected to the server via the network interface 126. An exemplary user device 120 may include a touchscreen, a keyboard, a mouse, a microphone, a speaker, a display, and/or any other suitable user interface devices.

Multi-turn (i.e., back-and-forth) conversations may require LLMs or SLMs to maintain context and/or coherence across multiple user prompts and/or utterances, which may require the ML chatbot to keep track of an entire conversation history as well as the current state of the conversation. The ML chatbot may rely on various techniques to engage in conversations with users, which may include the use of short-term and/or long-term memory. Short-term memory may temporarily store information that may be required for immediate use and/or may keep track of the current state of the conversation and/or understand the user's latest input in order to generate an appropriate response. Long-term memory may include persistent storage of information which may be accessed over an extended period of time. The long-term memory may be used by the ML chatbot to store information about the user (e.g., preferences, chat history, etc.) and/or may be useful for improving an overall user experience by enabling the ML chatbot to personalize and/or provide more informed responses.

The system and/or methods to generate and/or train an ML chatbot model (e.g., via the hazard training module 134a and/or the hazard detection module 134b of the server 130) which may be used by an ML chatbot, may consist of three steps: (1) a supervised fine-tuning (SFT) step where a pretrained language model (e.g., an LLM or SLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and/or improve the SFT ML model. The outcome of this step may be the ML chatbot model using an optimized policy. In one aspect, step one may take place only once, while steps two and/or three may be iterated continuously, e.g., more comparison data is collected on the current ML chatbot model, which may be used to optimize/update the reward model and/or further optimize/update the policy.

In some embodiments, the language model may be pre-trained by a set of vectors associated with a set of training data. The set of training data may include documents. Creating the set of vectors may include (1) extracting text from documents, (2) splitting the text into semantic clusters, and/or (3) encoding the semantic clusters as the set of vectors. The semantic clusters may be one or more words, a portion of a word, or a character. A distance between the vectors (e.g., a cosine distance, a Euclidean distance) may depend on a relevance between the semantic clusters corresponding to the vectors.

In some embodiments, the server 130 or an external computing device may encode the vectors using a trained machine learning model (such as the ML model in the hazard training module 134a and/or the hazard detection module 134b described herein above). In other embodiments, the server 130 may encode the vectors using existing encoding tables and/or libraries.

In other embodiments, user visual data may be sent via the network 110 to the server 130 using the visual data module 124a of the user device 120. The server 130 may receive user visual data depicting a kitchen with the stove on with the hazard detection module 134b. The hazard detection module 134b using the trained machine learning (ML) and/or artificial intelligence (AI) model may detect a hazardous condition in at least part of the user visual data because a stove has been unattended for more than one minute. The hazard notification generation module 134c may then generate and/or send a hazard notification to the user device 120. The user device 120 using the hazard notification module 124b may present the hazard notification to the user in the form of a chat-bot message.

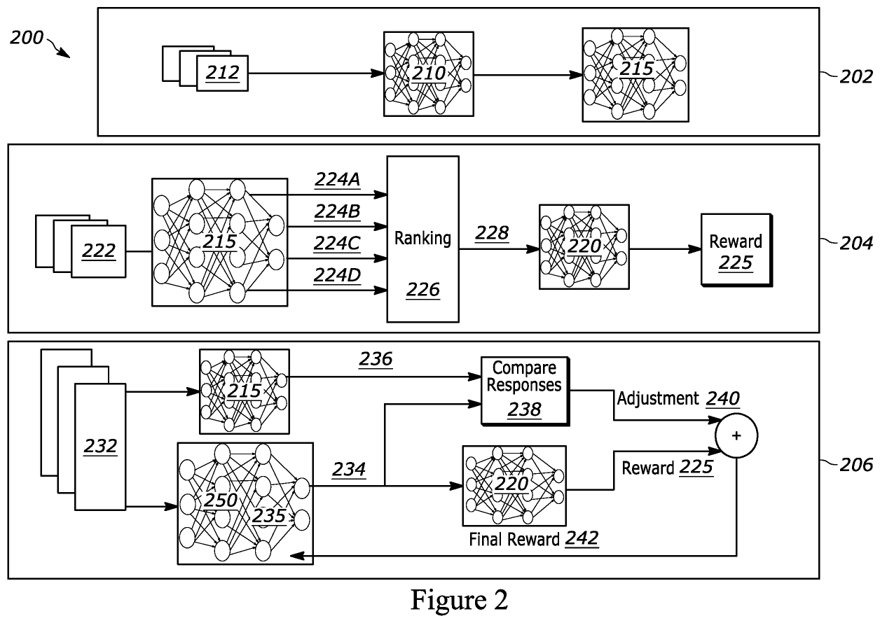

Depending on the embodiment, a language model may be an LLM, an SLM, or any other such language model. In some such embodiments, SLMs and LLMs may differ by a number of parameters used in the model (e.g., an SLM may be any model with fewer than 100 million parameters, 10 million parameters, 1 million parameters, etc., while an LLM may have more than 1 million parameters, 10 million parameters, 100 million parameters, 1 billion parameters, 10 billion parameters, 100 billion parameters, etc.). Similarly, SLMs may improve computation efficiency, cost, and/or customizability while LLMs may improve overall language model capacity and capabilities. In some embodiments, the above techniques may be directed to either LLMs or SLMs. In further embodiments, additional training techniques may be used to adapt the above techniques for training SLMs. For example, use a training model as described herein (e.g., with regard to FIG. 2) with fewer parameters. Similarly, an SLM may use the training techniques described above to broadly teach language capabilities before specializing to a narrower linguistic domain. Similarly, the training techniques may be applied via self-supervising training for LLMs or SLMs to function as an interactive predictive challenge (e.g., to determine a masked or corrupted next word in a sequence as pretraining or full training as described herein).

It is to be understood that the foregoing is a non-exhaustive illustration of the embodiments of the present invention and is not intended to limit any potential other embodiments in anyway.

### Supervised Fine-Tuning Machine Learning (ML) Model

FIG. 2 depicts an exemplary combined block and logic diagram 200 for training an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., 212), and other blocks may represent output data (e.g., 225). Input and/or output signals may be represented by arrows labeled with corresponding signal names and/or other identifiers. The methods and/or systems may include one or more servers 202, 204, 206, such as the server 130 or an external computing device.

In one aspect, the server 202 may fine-tune a pretrained language model 210. The pretrained language model 210 may be obtained by the server 202 and/or be stored in a memory, such as the memory 134. The pretrained language model 210 may be loaded into an ML training module, such as the hazard training module 134a, by the server 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory of the server 202, e.g., the memory 134 or the hazard database 140. In one aspect, the data labelers may create the supervised training dataset 212 prompts and/or appropriate responses. The pretrained language model 210 may be fine-tuned using the supervised training dataset 212, resulting in the SFT ML model 215, which may provide appropriate responses to user prompts once trained. The trained SFT ML model 215 may be stored in a memory of the server 202, e.g., memory 134 and/or the hazard database 140.

In some embodiments, the server 202 may fine-tune the pretrained language model 210 using a set of vectors associated with a set of training data. In some instances, the set of training data may include (1) prompts associated with hazard detection, (2) data associated with hazards, (3) environment metrics associated with potential hazards, and/or (4) recommendations associated with the data associated with hazards, the environment metrics associated with hazards, and/or the prompts associated with the hazards. Creating the set of vectors may include (1) splitting the text of the prompts into semantic clusters, and/or (2) encoding the semantic clusters as the set of vectors. The semantic clusters may be one or more words, a portion of a word, or a character. A distance between the vectors (e.g., a cosine distance, a Euclidean distance) may depend on a relevance between the semantic clusters corresponding to the vectors.

In some embodiments, the recommendations used to train the chatbot include a hazard mitigation technique and/or an addition of a hazard mitigating object. In some embodiments, the recommendations used to train the chatbot further include step-by-step instructions for performing the recommended action.

### Exemplary Training of the Model

In one aspect, training the ML chatbot model 250 may include the server 204 training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize its reward 225, and/or in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the visual data module of the server, such as visual data module 124a. The prompt 222 may be previously unknown to the SFT ML model 215, e.g., the labelers may generate new prompt data, the prompt 222 may include testing data stored on the hazard database 140, and/or any other suitable prompt data. The SFT ML model 215 may generate multiple, different output responses 224A, 224B, 224D, 224D to the single prompt 222. The server 204 may output the responses 224A, 224B, 224D, 224D via an I/O module (e.g., I/O module 136) to a user interface device, such as a display (e.g., as text responses), a speaker (e.g., as audio/voice responses), and/or any other suitable manner of output of the responses 224A, 224B, 224D, 224D for review by the data labelers.

The data labelers may provide feedback via the server 204 on the responses 224A, 224B, 224D, 224D when ranking 226 them from best to worst based upon the prompt-response pairs. The data labelers may rank 226 the responses 224A, 224B, 224D, 224D by labeling the associated data. The ranked prompt-response pairs 228 may be used to train the reward model 220. In one aspect, the server 204 may load the reward model 220 via the ML module (e.g., the ML module 130) and/or train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and/or a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 225 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 120 over network 110 to the server 204 running a chatbot application utilizing the SFT ML model 215. The SFT ML model 215 may provide as output responses to the labeler via the user device 120: (i) “the sky is above” 224A; (ii) “the sky includes the atmosphere and may be considered a place between the ground and outer space” 224B; and/or (iii) “the sky is heavenly” 224D. The data labeler may rank 226, via labeling the prompt-response pairs, prompt-response pair 222/224B as the most preferred answer; prompt-response pair 222/224A as a less preferred answer; and prompt-response 222/224D as the least preferred answer. The labeler may rank 226 the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response, such as text to the prompt, and/or the reward model 220 may receive the response to generate a scalar reward 225 of how well humans perceive it. Reinforcement learning may optimize the SFT model 215 with respect to the reward model 220 which may realize the configured ML chatbot model 250.

Reinforcement Learning from Human Feedback (RLHF) to Train the Machine Learning (ML) Chatbot Model

In one aspect, the server 206 may train the ML chatbot model 250 (e.g., via the hazard training module 134a) to generate a response 234 to a random, new and/or previously unknown user prompt 232. To generate the response 234, the ML chatbot model 250 may use a policy 235 (e.g., algorithm) which it learns during training of the reward model 220, and/or in doing so may advance from the SFT model 215 to the ML chatbot model 250. The policy 235 may represent a strategy that the ML chatbot model 250 learns to maximize its reward 225. As discussed herein, based upon prompt-response pairs, a human labeler may continuously provide feedback to assist in determining how well the ML chatbot's 250 responses match expected responses to determine rewards or incentives 225. The rewards 225 (such as discounts, incentives, or other cost savings) may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 250 using the policy 235 based upon the reward 225 may be compared using an adjustment function 238 to the SFT ML model 215 (which may not use a policy) response 236 of the same prompt 232. The adjustment function 238 may be trained in a similar manner and/or contemporaneous with the reward model 220. The server 206 may compute an adjustment 240 based upon the adjustment function 238 of the responses 234, 236. The adjustment 240 may reduce the distance between the responses 234, 236, i.e., a statistical distance measuring how one probability distribution is different from a second, in one aspect the response 234 of the ML chatbot model 250 versus the response 236 of the SFT model 215. Using the adjustment 240 to reduce the distance between the responses 234, 236 may avoid a server over-optimizing the reward model 220 and/or deviating too drastically from the human-intended/preferred response. Without the adjustment 240, the ML chatbot model 250 optimizations may result in generating responses 234 which are unreasonable but may still result in the reward model 220 outputting a high reward 225.

The responses 234 of the ML chatbot model 250 using the current policy 235 may be passed by the server 206 to the rewards model 220, which may return the scalar reward 225. The ML chatbot model 250 response 234 may be compared via the adjustment function 238 to the SFT ML model 215 response 236 by the server 206 to compute the adjustment 240. The server 206 may generate a final reward 242 which may include the scalar reward 225 offset and/or restricted by the adjustment 240. The final reward 242 may be provided by the server 206 to the ML chatbot model 250 and/or may update the policy 235, which in turn may improve the functionality of the ML chatbot model 250.

To optimize the ML chatbot 250 over time, RLHF via the human labeler feedback may continue ranking 226 responses of the ML chatbot model 250 versus outputs of earlier/other versions of the SFT ML model 215, i.e., providing positive or negative rewards 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and/or throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

In some embodiments, the server 204 may train and/or fine-tune the ML chatbot model 250 in connection with a feedback server (such as the server 130 or an external computing device) that provides feedback to the ML chatbot model 250. While training and/or fine-tuning the ML chatbot model 250, the ML chatbot model 250 may output one or more recommend actions for hazard mitigation based upon an input prompt. The feedback server may receive the one or more recommendations output by the ML chatbot model 250 and/or then determine a change of one or more metric values associated with hazard detection when implementing the one or more recommendations. The feedback server may then provide the change to the server 204. Accordingly, the reward model 220 and/or the adjustment function 238 may utilize the change in one or more metric values associated with hazard detection as input to determine the scalar reward 225 and/or the adjustment 240 associated with the one or more recommendations. In this way, the ML chatbot model 250 may be trained and/or fine-tuned to provide better recommendations based upon the hazards detected.

In other embodiments, the server 204 may train and/or fine-tune the ML chatbot model 250 with labelled training data including scenes of a particular environment (e.g., a kitchen) some with a hazardous condition present (e.g., flammable material in proximity to a candle labelled as “fire hazard”), others without a hazardous condition present (e.g., labelled as “no hazardous condition present”). The training data may include a plurality of hazard levels for different hazards (e.g., flammable material in proximity to a candle labelled as “hazard level I”, an unattended stove labelled as “hazard level II”, and/or a grease fire labeled as “hazard level III”, etc.) in different environments (e.g., an open flame in a kitchen is labelled as “hazard level III” and/or an open flame in a firepit in the backyard is labelled as “no hazardous condition present”). The ML chatbot model 250 may take as input visual data and/or determine if/when hazard levels in a particular environment (e.g., a kitchen) changes.

In some embodiments, the server 204 may train and/or fine-tune the ML chatbot model 250 with user specified rules to ensure only desired hazardous conditions are detected. For example, the ML chatbot model may only detect a drowning risk when a child is near the pool if the child is shorter than a specified height (e.g., the depth of the pool). In other embodiments, because of a user specific rule the ML chatbot model may only detect a drowning risk when a pool is filled to a specified level (e.g., two inches). In yet another embodiment, a user may specify an acceptable period (e.g., one minute) in which a hazardous condition (e.g., an unattended stove) may exist before a hazard notification is generated.

It is to be understood that the foregoing is a non-exhaustive illustration of the embodiments of the present invention and is not intended to limit any potential other embodiments in anyway.

### Exemplary Hazard Detection

Some of the elements of FIG. 3A and/or 3B may include components as described herein with respect to FIGS. 1 and/or 2. Furthermore it should be understood that FIGS. 3A and/or 3B may include additional, fewer, or alternate components to those described herein with respect to FIGS. 1 and/or 2.

FIG. 3A depicts an exemplary hazard detection scenario 300A and/or interaction between a user and the machine learning (ML) and/or artificial intelligence (AI) model. Depending on the embodiment, and as described herein, the exemplary hazard detection scenario 300A may include a user device 120 and/or user visual data 302 representative of a particular environment. The user visual data 302 representative of a particular environment may be various forms of visual data (e.g., image, photo, pre-recorded video, live video feed, etc.).

In some embodiments, a user may specify rules for the trained machine learning (ML) and/or artificial intelligence (AI) model to ensure only desired hazardous conditions are detected. For example, the trained machine learning (ML) and/or artificial intelligence (AI) model may only detect a drowning risk when a child is near the pool if the child is shorter than a specified height (e.g., the depth of the pool). In other embodiments, because of a user specific rule, the trained machine learning (ML) and/or artificial intelligence (AI) model may only detect a drowning risk when a pool is filled to a specified level (e.g., two inches). In yet another embodiment, a user may specify an acceptable period (e.g., one minute) in which a hazardous condition (e.g., an unattended stove) may exist before a hazard notification is generated.

In other embodiments, a specified rule may change who or what an unauthorized entity is. An unauthorized entity may be any person or animal (e.g., a child, a grandparent, a non-homeowner, a dog, a cat, a gerbil, etc.) or object (e.g., an automatic lawn mower, a self-driving car, etc.) whose presence in a particular environment may cause the trained machine learning (ML) and/or artificial intelligence (AI) model to detect a hazardous condition (e.g., due to potential for damage). For example, a user may specify their three year old child as an unauthorized entity. The trained machine learning (ML) and/or artificial intelligence (AI) model may thereafter detect a hazardous condition when the three year old child is classified as in proximity to a pool. It is to be understood that the user specified rules are not limited to the foregoing examples and may include a plurality of other parameters whether discussed herein or otherwise.

In some embodiments, different levels of hazards may be detected based upon parameters such as the length of time a hazardous condition has been present, a determined risk to an individual, a likelihood of damage to property, etc. FIG. 3A depicts an exemplary level II hazard because the stove is on and/or has been unattended for 60 seconds as calculated by six consecutive photos sent ten seconds apart each without the presence of an adult in the image. In response to a level II hazard being detected, the server 130 generates a hazard notification to that effect using the hazard notification generation module 134c and/or sends it to the user device 120. The hazard notification generation module 134c may generate and/or include links, uniform resource locators (URLs), hyperlinks, etc. to safety videos (e.g., a fire safety video) or instructions for mitigating/eliminating the hazard (e.g., instructions for turning off an appliance) in the hazard notification. In further embodiments, the hazard notification generation module 134c (and/or other components communicatively coupled to the hazard notification generation module 134c) may provide and/or generate a predicted lifespan for an object in an environment before the object becomes a hazard (or, in the case of hazard mitigating objects, will no longer sufficiently mitigate the hazard).

In some embodiments, the safety video or instructions for mitigating/eliminating the hazard may be triggered based upon the level of hazard detected (e.g., level I hazard may be a simple safety video, level II may be instructions and/or recommendations for mitigating the hazardous condition, level III may be instructions for eliminating the hazardous condition, etc.). In further embodiments, the hazard notification, safety video, instructions, and/or other such indication may be triggered based upon the change from a first hazard level (e.g., level I) to a second hazard level (e.g., level II). In still further embodiments, the hazard notifications may be sent and/or generated periodically (e.g., every 5 minutes, every hour, every day, every week, etc.) until the hazard is no longer detected, a mitigating object and/or safety feature has been included, etc.

In some embodiments, a user (e.g., a homeowner, a caretaker, a guardian, etc.) may install a user device 120 (e.g., a video camera, a security camera, a pet camera, etc.) to capture and/or send user visual data 302 to the server 130 via the network 110 to detect hazards. In some embodiments, the user device 120 may be configured to periodically and/or on a scheduled basis (e.g., every second, every minute, every hour, every Thursday, every second week, on the 21^{st} of September, etc.) send a picture or other visual data of a particular environment (e.g., a kitchen, a bedroom, a living room, etc.) to the server 130. In other embodiments, a user device 120 may be configured to capture and/or send user visual data 302 to the server 130 via the network 110 upon the detection of a hazard (e.g., using user visual data and/or non-visual sensor data from another computing device).

In yet further embodiments, the user device 120 may constantly capture images or videos and/or store the user visual data 302 (e.g., in the visual data module 124 of memory 124, in the hazard data module 152a of memory 152, etc.). When prompted by a user (e.g., via a user request, via an email, via a phone call, etc.) or a particular event trigger (e.g., due to a hazard being detected, etc.) a portion of the stored user visual data 302 may be sent to the server 130 via the network 110 for hazard detection.

In further embodiments, the user device 120 (e.g., a smartphone) may be connected to a visual data sensor, such as a Wi-Fi enabled smart camera. The Wi-Fi enabled smart camera may capture and/or send user visual data 302 to the user device 120 which may in turn send the visual data 302 to the hazard detection module 134b of the server 130. In other embodiments, the Wi-Fi enabled smart camera may be the user device 120 and/or perform the same functionality (e.g., sending user visual data 302 directly to the server 130) as described herein.

In more exemplary embodiments, the user device 120 may not collect any visual data 302 on an environment. Instead, the smart device 140 (e.g., a Wi-Fi enabled carbon monoxide detector, a smart smoke detector, a sump pump, motion detector (e.g., on an outside door), smart tag, global positioning system (GPS) sensor, etc.) may be responsible for collecting non-visual sensor data (e.g., carbon monoxide levels, smoke levels, water levels, etc.) on an environment (e.g., a bedroom, a kitchen, a basement, etc.) and/or sending it to the server 130 for use by the hazard detection module 134b. In some such embodiments, a user may manually capture visual data to supplement the non-visual sensor data. It should be understood that any of the embodiments described with respect to the user device 120 and/or user visual data 302 may also be embodied by the smart device 140 and/or non-visual sensor data.

In further embodiments, the hazard notification generation module 134c may send the hazard notification to one or more of the user device 120 and/or the smart device 140 depending upon the location of the detected hazard. For example, if a smart device 140 (e.g., a carbon monoxide detector) is in the basement and/or a hazard is detected, then a hazard notification may be sent to the user device 120 (e.g., a homeowner's smartphone next to their bed) and/or another smart device 140 (e.g., a smart home audio system configured throughout the home) rather than just sending the hazard notification to the smart device 140 (e.g., the carbon monoxide detector located in the basement). As discussed herein, various sub-components of the exemplary computing environment 100 (e.g., the user device 120, the smart device 140) may provide a hazard notification to the user. In some embodiments, the smart device 140 is better positioned to provide the user a hazard notification. In other embodiments, the user device 120 is in a better position to provide the user a hazard notification. While the user device 120 and/or the smart device 140 are depicted as components of the exemplary computing environment 100, it is to be understood that other similar computing devices may be capable of receiving a hazard notification depending on the embodiment.

FIG. 3B depicts another exemplary hazard detection scenario. The user visual data 302 (e.g., a live video feed) depicting a backyard environment with a pool may be sent via a user device 120, which may be connected to a Wi-Fi enabled camera, to the server 130. The server 130 using the machine learning (ML) and/or artificial intelligence (AI) model may classify the user visual data 302 as a detected hazardous condition because an unauthorized entity, such as a child has been left unattended near a pool.

The server 130 may generate a hazard notification in the form of a chat message with prompts to safety videos or instructions for mitigating/eliminating the hazard, such as playing a sound on the Wi-Fi enabled camera instructing the child to stay away from the pool or to find an adult. In other embodiments, the Wi-Fi enabled camera, may be the user device 120 and/or directly send the video feed to the server 130 thereby reducing any delays or other potential associated concerns with wireless connections.

In further embodiments, the presence of a hazard mitigating object (e.g., a pool floatation device around the waist of a child) may cause the machine learning (ML) and/or artificial intelligence (AI) model to dismiss a hazard (e.g., a drowning risk). In other embodiments, the hazard mitigating object may reduce the level of the detected hazard (e.g., a child near a pool with a floatation device is a level I hazard instead of a level II hazard in the absence of a floatation device).

In some embodiments, the intensity of the hazard notification may be proportional to the level of the hazard detected. For example, a smart device 140 such as a temperature sensor may be positioned to measure the temperature of a stove. The smart device 140 using the non-visual sensor data module 144a sends non-visual sensor data via the network 110 to the server 130. The server 130 using the hazard detection module 134b. The trained machine learning (ML) and/or artificial intelligence (AI) model may detect a hazardous condition because the temperature of the stove has reached a point in which burns are possible. The server 130 using the hazard notification generation module 134c, may generate a hazard notification including a vibration with medium intensity. The hazard notification may be sent to a smart device 140 such as the smart watch of an individual detected in the environment (e.g., via user visual data 302 captured by a user device 120). As the individual detected in the environment gets closer to the stove the intensity of the vibration from the hazard notification may increase. In other embodiments, the intensity of the hazard notification may be proportional to the temperature of the stove.

In further embodiments, a user may assess hazards (e.g., water leakages or overflows) on a property on, in, and/or outside a home. For example, a user device 120 such as a thermal imaging camera may capture a video depicting an attic environment. The user device 120 may send the user visual data 302 using the visual data module 124a via the network 110 to the server 130. The server 130 using the hazard detection module 134b may detect a hazardous condition, such as a water leak due to the presence of a cold spot indicating the roof is at risk of leaking. A hazard notification to that effect may be generated by the hazard notification generation module 134c and/or sent to the user device 120 to be presented to the user using the hazard notification module 124b. In other embodiments, the thermal imaging camera may be outside the home and/or the presence of hotspots on a cold day may be indicative of improper insulation among other hazards.

It is to be understood that the foregoing is a non-exhaustive illustration of the embodiments of the present invention and is not intended to limit any potential other embodiments in anyway.

### Exemplary Hazard Detection Flowchart

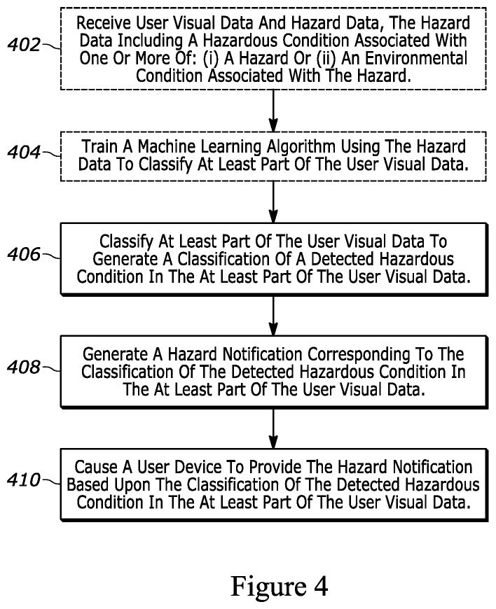

FIG. 4 depicts an exemplary hazard detection flow chart 400 which may be implemented in the computer systems and/or embodiments of FIGS. 1-3C as described herein. It will be understood that any such reference is for ease of explanation only, and should not be construed to be limiting to that particular embodiment. As such, it will be understood that alternate systems and/or components may implement the steps described below.

The exemplary computer-implemented (or computer-based) method 400 may include receiving user visual data 302 and/or hazard data including a hazardous condition associated with one or more of: (i) a hazard or (ii) an environmental condition associated with the hazard (block 402). In some embodiments, the hazard data may include a hazard level of a plurality of hazard levels associated with the classification of the detected hazardous condition in the at least part of the user visual data 302. For example, a hazardous condition that does not pose a significant risk to life or health may be a level I hazard whereas a hazardous condition that poses a significant risk to health may be a level II hazard, and/or a hazardous condition that poses a significant risk to life may be a level III hazard, etc. Similarly, a hazardous condition that only poses a risk to property may be a lower hazard level than a hazardous condition that poses a risk to life and/or health.

The exemplary computer-implemented method 400 may then include training a machine learning (ML) and/or artificial intelligence (AI) model using the hazard data to classify at least part of the user visual data (block 404). In some embodiments, the hazard data used for training the machine learning algorithm may include a known hazardous condition associated with a hazard mitigating object. For instance, a hazardous condition, such as a fire risk, may be associated with a hazard mitigating object like a fire extinguisher. Similarly, a hazardous condition, such as injury from riding a bike, may be associated with a hazard mitigating object like a bike helmet. Again, a hazardous condition, such as a drowning risk, may be associated with a hazard mitigating object like the presence of a fence or barrier around a pool.

In other embodiments, the hazardous conditions associated with the hazard mitigating object may be a defect with the hazard mitigating object. For example, a hazardous condition, such as a fire risk, may be associated with a defective hazard mitigating object like a non-code compliant fire extinguisher. Moreover, a hazardous condition such as injury from riding a bike may be associated with a defective hazard mitigating object like a bike helmet that does not fit correctly, a user wearing clothes that are not reflective enough, a bike missing safety features, such as lights, etc. Further still, a hazardous condition, such as a drowning risk, may be associated with a defective hazard mitigating object like a fence or barrier around a pool that may be easily climbed by a child.

The exemplary computer-implemented method 400 may then include classifying at least part of the user visual data to generate a classification of a detected hazardous condition in the at least part of the user visual data (block 406). In some embodiments, the detected hazardous condition may be representative of the presence of an unauthorized entity. For example, a detected hazardous condition, such as a fire risk, may be representative of the presence of a child near an unattended stove. Similarly, a detected hazardous condition, such as a bike fall risk, may be representative of the presence of a child on an adult sized bike. Yet again, a detected hazardous condition, like a drowning risk, may be representative of the presence of a child near a pool. As a further example, a detected hazardous condition may be or include more subtle indications, such as a crack in a seal or pipe (e.g., for a toilet, sump pump, sprinkler system, etc.), a discoloration in water, missing safety features, etc.

The exemplary computer-implemented method 400 may then include generating a hazard notification corresponding to the classification of the detected hazardous condition in the at least part of the user visual data (block 408). In other embodiments, the hazard notification may include a recommended action based upon the detected hazardous condition in the at least part of the user visual data. For example, a hazardous condition, such as a leaking toilet may be detected. The recommended action may be step-by-step instructions on how to fix the leaking toilet, a recommended list of certified local plumbers, a recommended list of stores that sell toilet parts, etc. In further embodiments, the generated hazard notification may be or include a video including one or more tips for addressing potential hazards (e.g., by adding safety features, adding mitigating objects, moving items away from a potentially hazardous area (e.g., a fireplace), etc.).

The exemplary computer-implemented method 400 may then include causing a user device to provide the hazard notification based upon the classification of the detected hazardous condition in the at least part of the user visual data (block 410). In some embodiments, the intensity of the hazard notification may be proportional to the level of the hazard detected. For example, a temperature sensor may measure the temperature of a stove and/or send non-visual sensor data to be detected for hazards. The trained machine learning (ML) and/or artificial intelligence (AI) model may detect a hazardous condition because the temperature of the stove has reached a point in which burns are possible. Resultingly, the hazard notification may include a vibration with medium intensity. The hazard notification may be sent the smart watch of an individual detected in the environment. Furthermore, as the individual detected in the environment gets closer to the stove the intensity of the vibration from the hazard notification may increase. In other embodiments, the intensity of the hazard notification may be proportional to the temperature of the stove.

It is to be understood that the foregoing is a non-exhaustive illustration of the embodiments of the present invention and is not intended to limit any potential other embodiments in anyway.

### Additional Considerations

Unless otherwise indicated, the processes implemented by an ML chatbot may be implemented by an ML voice bot, an AI chatbot, an AI voice bot, a large language model (LLM), and/or a small language model (SLM).

The term “machine learning (ML) and/or artificial intelligence (AI) model” as it is used herein is defined to mean a machine learning algorithm or any other exemplary machine learning (ML) and/or artificial intelligence (AI) algorithm and/or model. It will be understood that the terms “ML” and “AI” may be used interchangeably herein, and should be considered as such except where indicated to the contrary. With the foregoing, an insurance customer may opt-in to a rewards, insurance discount, or other type of program. After the insurance customer provides their affirmative consent, an insurance provider remote server may collect data from the customer's mobile device, smart home controller, or other smart devices-such as with the customer's permission or affirmative consent. The data collected may be related to smart home functionality (or home occupant preferences or preference profiles), and/or insured assets before (and/or after) an insurance-related event, including those events discussed elsewhere herein. In return, risk averse insureds, homeowners, or home or apartment occupants may receive discounts or insurance savings related to home, renters, personal articles, auto, and other types of insurance from the insurance provider.

In one aspect, smart or interconnected home data, and/or other data, including the types of data discussed elsewhere herein, may be collected or received by an insurance provider remote server, such as via direct or indirect wireless communication or data transmission from a smart home controller, mobile device, or other customer computing device, after a customer affirmatively consents or otherwise opts-in to an insurance discount, reward, or other program. The insurance provider may then analyze the data received with the customer's permission to provide benefits to the customer. As a result, risk averse customers may receive insurance discounts or other insurance savings based upon data that reflects low risk behavior and/or technology that mitigates or prevents risk to (i) insured assets, such as homes, personal belongings, or vehicles, and/or (ii) home or apartment occupants.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112 (f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by resource and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or

B is satisfied by any one of the following: A is true (or present), and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

The systems and methods described herein are directed to an improvement to computer functionality, and improve the functioning of conventional computer systems.

What is claimed is:

1. A computer-implemented method for identifying hazards, the method comprising:
receiving, by one or more processors and at least one database, user visual data and hazard data, the hazard data including a hazardous condition associated with one or more of: (i) a hazard or (ii) an environmental condition associated with the hazard;
training, by the one or more processors and using the hazard data, a machine learning algorithm to classify at least part of the user visual data;
classifying, by the one or more processors and using the machine learning algorithm, at least part of the user visual data to generate a classification of a detected hazardous condition in the at least part of the user visual data;
generating, by the one or more processors, a hazard notification corresponding to the classification of the detected hazardous condition in the at least part of the user visual data; and
causing, by the one or more processors, a user device to provide the hazard notification based upon the classification of the detected hazardous condition in the at least part of the user visual data.

2. The computer-implemented method of claim 1, wherein the hazard notification further includes a hazard level of a plurality of hazard levels associated with the classification of the detected hazardous condition in the at least part of the user visual data.

3. The computer-implemented method of claim 1, wherein the hazard notification includes a recommended action based upon the detected hazardous condition in the at least part of the user visual data.

4. The computer-implemented method of claim 1, wherein the hazard data further includes one or more known hazardous conditions associated with a hazard mitigating object.

5. The computer-implemented method of claim 4, wherein the one or more hazardous conditions associated with the hazard mitigating object is a defect with the hazard mitigating object.

6. The computer-implemented method of claim 1, wherein the hazardous condition is representative of a presence of an unauthorized entity.

7. The computer-implemented method of claim 1, further comprising:
receiving, by the one or more processors, non-visual sensor data;
classifying, by the one or more processors and using the machine learning algorithm, at least part of the non-visual sensor data to generate a classification of a detected hazardous condition in the at least part of the non-visual sensor data;
generating, by the one or more processors, a hazard notification corresponding to the classification of the detected hazardous condition in the at least part of the non-visual sensor data; and
causing, by the one or more processors, the user device to provide the hazard notification based upon the classification of the detected hazardous condition in the at least part of the non-visual sensor data.

8. A computing system for identifying hazards, comprising:
one or more processors; and
a non-transitory computer-readable memory coupled to the one or more processors, the memory storing instructions thereon that, when executed by the one or more processors, cause the one or more processors to:
receive, from at least one database, user visual data and hazard data, the hazard data including a hazardous condition associated with one or more of: (i) a hazard or (ii) an environmental condition associated with the hazard;
train, using the hazard data, a machine learning algorithm to classify at least part of the user visual data;
classify, using the machine learning algorithm, at least part of the user visual data to generate a classification of a detected hazardous condition in the at least part of the user visual data;
generate a hazard notification corresponding to the classification of the detected hazardous condition in the at least part of the user visual data; and
cause a user device to provide the hazard notification based upon the classification of the detected hazardous condition in the at least part of the user visual data.

9. The computing system of claim 8, wherein the hazard notification further includes a hazard level of a plurality of hazard levels associated with the classification of the detected hazardous condition in the at least part of the user visual data.

10. The computing system of claim 8, wherein the hazard notification includes a recommended action based upon the detected hazardous condition in the at least part of the user visual data.

11. The computing system of claim 8, wherein the hazard data further includes one or more known hazardous conditions associated with a hazard mitigating object.

12. The computing system of claim 11, wherein the one or more hazardous conditions associated with the hazard mitigating object is a defect with the hazard mitigating object.

13. The computing system of claim 8, wherein the hazardous condition is representative of a presence of an unauthorized entity.

14. The computing system of claim 8, wherein the non-transitory computer-readable memory further stores instructions that, when executed by the one or more processors, cause the one or more processors to:
receive non-visual sensor data;
classify, using the machine learning algorithm, at least part of the non-visual sensor data to generate a classification of a detected hazardous condition in the at least part of the non-visual sensor data;
generate a hazard notification corresponding to the classification of the detected hazardous condition in the at least part of the non-visual sensor data; and
cause the user device to provide the hazard notification based upon the classification of the detected hazardous condition in the at least part of the non-visual sensor data.

15. A tangible, non-transitory computer-readable medium storing instructions for identifying hazards that, when executed by one or more processors of a computing device, cause the computing device to:
receive, from at least one database, user visual data and hazard data, the hazard data including a hazardous condition associated with one or more of: (i) a hazard or (ii) an environmental condition associated with the hazard;
train, using the hazard data, a machine learning algorithm to classify at least part of the user visual data;
classify, using the machine learning algorithm, at least part of the user visual data to generate a classification of a detected hazardous condition in the at least part of the user visual data;
generate a hazard notification corresponding to the classification of the detected hazardous condition in the at least part of the user visual data; and
cause a user device to provide the hazard notification based upon the classification of the detected hazardous condition in the at least part of the user visual data.

16. The tangible, non-transitory computer-readable medium of claim 15, wherein the hazard notification further includes a hazard level of a plurality of hazard levels associated with the classification of the detected hazardous condition in the at least part of the user visual data.

17. The tangible, non-transitory computer-readable medium of claim 15, wherein the hazard data further includes one or more known hazardous conditions associated with a hazard mitigating object.

18. The tangible, non-transitory computer-readable medium of claim 15, wherein the one or more hazardous conditions associated with the hazard mitigating object is a defect with the hazard mitigating object.

19. The tangible, non-transitory computer-readable medium of claim 18, wherein the hazardous condition is representative of a presence of an unauthorized entity.

20. The tangible, non-transitory computer-readable medium of claim 15, further comprising instructions for identifying hazards that, when executed by the one or more processors of the computing device, cause the computing device to:
receive non-visual sensor data;
classify using the machine learning algorithm, at least part of the non-visual sensor data to generate a classification of a detected hazardous condition in the at least part of the non-visual sensor data;
generate a hazard notification corresponding to the classification of the detected hazardous condition in the at least part of the non-visual sensor data; and
cause the user device to provide the hazard notification based upon the classification of the detected hazardous condition in the at least part of the non-visual sensor data.
